(19) United States
(12) Patent Application Publication
(10) Pub. No.: US 2019/0185692 A1
(43) Pub. Date: Jun. 20, 2019

(54) INK COMPOSITIONS

(71) Applicant: Hewlett-Packard Development Company, L.P., Fort Collins, CO (US)

(72) Inventors: Milton Neill JACKSON, Corvallis, OR (US); Larrie DEARDURFF, Corvallis, OR (US); Jayprakash C. Bhatt, Corvallis, OR (US)

(73) Assignee: Hewlett-Packard Development Company, L.P., Fort Collins, CO (US)

(21) Appl. No.: 16/308,651

(22) PCT Filed: Oct. 4, 2016
(86) PCT No.: PCT/US2016/055274

§ 371 Date: Dec. 10, 2018

(51) Int. Cl. C09D 11/322; C09D 11/38

(52) U.S. Cl. CPC C09D 11/322; C09D 11/38

(57) ABSTRACT

The present disclosure is drawn to ink compositions including from 30 wt % to 75 wt % water, an organic co-solvent system, from 0.1 wt % to 3 w % nonionic surfactant, and from 3 wt % to 9 wt % pigment that is dispersed by separate polymer dispersant. The organic co-solvent system can include, based on the ink composition content, from 15 wt % to 50 wt % of a first solvent portion of high dielectric constant co-solvent with a dielectric constant greater than 30 ε, and from 2 wt % to 15 wt % of a second solvent portion of low dielectric constant co-solvent with a dielectric constant from 1 ε to 30 ε.

### BACKGROUND

Color pigments are typically dispersed or suspended in a liquid vehicle to be utilized in inks. A variety of colored pigments are difficult to disperse and stabilize in water-based vehicles due to the nature of the surface of pigments and the self-assembling behavior of pigments. One way to facilitate color pigment dispersion and sustained suspension in a liquid vehicle is to adding a dispersant, such as a polymer, to the liquid vehicle. Another way to stabilize pigment is to covalently attach a small molecule, oligomer, or polymer to a surface of the pigment to form a self-dispersed pigment. Regardless of the technique of dispersion, the attached or unattached dispersant stabilizes the pigment in the fluid. Pigments that are made to be very stable can often penetrate print media resulting in low color saturation. Thus, enhancing color saturation of ink compositions containing pigments would be a desirable property to achieve generally.

### BRIEF DESCRIPTION OF THE DRAWINGS

Additional features and advantages of the disclosure will be apparent from the detailed description which follows, taken in conjunction with the accompanying drawings, which together illustrate, by way of example, features of the present technology. It should be understood that the figures are representative examples of the present technology and should not be considered as limiting the scope of the technology.

FIG. 1 depicts a bar graph of primary and secondary color saturation comparing various low ε dielectric constant co-solvents in accordance with examples of the present disclosure;

FIG. 2 depicts a bar graph of primary and secondary color saturation comparing various low ε dielectric constant co-solvents in accordance with examples of the present disclosure; and

FIG. 3 depicts a bar graph of primary and secondary color saturation comparing various low ε dielectric constant co-solvents in accordance with examples of the present disclosure.

### DETAILED DESCRIPTION

The present disclosure is drawn to ink compositions, methods of making ink compositions, and inkjet printing systems. In accordance with the present disclosure, a color pigment that would otherwise clump together and settle out of the liquid vehicle can be suspended if the pigment is modified with a covalently attached small molecule, oligomer, or polymer, or if the pigment is dispersed with a polymer dispersant that becomes associated with the pigment. Two principal mechanisms of stabilization for self-dispersed and polymer dispersed pigments include steric stabilization and electrostatic stabilization. In the present disclosure in particular, electrostatic stabilization can be relevant to tuning the saturation, or more particularly, increase the color saturation of the pigment when printed on plain paper or other non-ColorLok® media.

Electrostatic stabilization occurs when the outer surface of the pigments becomes essentially equally charged (or charged at least enough to remain suspended) in the suspension fluid. The equal charge on the outer surface of individual colored pigments results in a Coulomb-repulsion that prevents individual dispersed colored pigments from clumping together. Often, inks are prepared with a lot of margin of stability, meaning that pigments are not only stabilized, but the formulations include dispersing agent and/or ink conditions that make the pigment very stable in the ink. With a large margin between pigment stability and pigment crashing, the very stable pigment tends to want to stay with the ink formulation and thus, often penetrates into the plain paper media substrates, reducing color saturation. The ink compositions and methods described herein provide a way to control electrostatic stabilization of ink compositions, reducing the margin between pigment stabilization and pigment crash, by using a low dielectric co-solvent in combination with additional co-solvent and pigments that are dispersed with a polymer dispersant. Under such conditions, enhancement or increase of color saturation of the ink compositions when printed on plain, non-ColorLok®, print media can be realized. In further detail, by the formulations described herein, the charge on the pigment can be selectively attenuated by reducing the liquid vehicle's ability to effectively separate charge stabilization of a pigment. The charge stabilization is reduce (not eliminated) to keep the pigment stabilized in the ink, but with only a small margin between a stabilized and crashing condition.

As mentioned, by including low ε dielectric constant co-solvent(s) (ε is from 1 to 30) in the liquid vehicle composition, the internal charge of the dispersed pigment can be attenuated. This change in dielectric properties of the liquid vehicle can influence color saturation on plain paper. For example, as the water in the liquid vehicle is absorbed into the plain paper media, this can result in a decrease in the dielectric constant of the vehicle surrounding the pigment, resulting in the pigment crashing on the surface of the media (compared to when the pigment is dispersed in the liquid vehicle within the inkjet fluid container where it is stable).

In further detail, pigment crashing can occur when the stabilization forces, e.g., steric and electrostatic stabilization, do not provide enough stabilization to keep the pigments separated in space enough to prevent pigment crashing. This can cause the pigment to crash in on itself because there is not enough separation between particles. Thus, in the context of the present disclosure, “crash” conditions can occur when the pigment is no longer stable in the ink composition. This can occur because low dielectric material may not be able to significantly support or transport charge. Therefore, in a low dielectric medium, charge particles are not “aware” of one another, e.g., they do not “see” or feel each other, until they get very close in proximity. In accordance with the present technology, when the pigments become close enough together, they begin to “crash” or aggregate with one another.

In accordance with this, the present disclosure is drawn to an ink composition including from 30 wt % to 75 wt % water, an organic co-solvent system, from 0.1 wt % to 3 w % nonionic surfactant, and from 3 wt % to 9 wt % pigment that is dispersed by separate polymer dispersant. The organic solvent system can include from 15 wt % to 50 wt % of a first solvent portion, the first solvent portion containing high dielectric constant co-solvent with a dielectric constant greater than 30 ε. The organic solvent system can further include from 2 wt % to 15 wt % of a second solvent portion. In one example, the second solvent portion can contain low dielectric constant co-solvent with a dielectric constant from 1 ε to 30 ε, or from 1 ε to 10 ε, or from 10 ε to 30 ε. In other examples, the second solvent portion can include multiple low dielectric constant co-solvents, or can include a single low dielectric constant co-solvent. The low dielectric constant co-solvent(s), in one example, can be one or more oxygen-containing co-solvent, such as an alcohol or alcohols, and/or urea, to name a few. If an alcohol is selected, examples can include ethanol, hexylene glycol, 2-propanol, neopentyl alcohol, isopropyl alcohol, or mixtures thereof.

In another example, a method of formulating an ink composition can include dispersing from 3 w % to 9 wt % pigment with a polymer dispersant and suspended in an aqueous liquid vehicle to form an ink composition. The aqueous liquid vehicle can include water, nonionic surfactant, and an organic co-solvent system. The organic co-solvent system can include from 15 wt % to 50 wt % of a first solvent portion with only high dielectric constant co-solvent with a dielectric constant greater than 30 ε, and from 2 wt % to 15 wt % of a second solvent portion containing low dielectric constant co-solvent with a dielectric constant from 1 ε to 30 ε. By way of specific examples, the low dielectric constant co-solvent can be or comprise an alcohol, e.g., one or more alcohol, and/or urea.

In another example, a method of printing can include jetting an ink composition onto a plain paper medium, absorbing a portion of the aqueous liquid vehicle in a surface of the plain paper medium, and crashing the pigment at the surface as a result of the aqueous liquid vehicle absorbing into the plain paper medium without the use of a crashing agent. The ink composition can include pigment and an organic co-solvent system. The organic co-solvent system can include from 15 wt % to 50 wt % of a first solvent portion selected from the group consisting of 2-pyrrolidinone, 2-ethyl-2-hydroxymethyl-1,3-propanediol, glycerol, LEG-1, hydroxyethyl-2-pyrrolidone, triethylene glycol, tetraethylene glycol, dantocol, and mixtures thereof; and from 2 wt % to 15 wt % of a second solvent portion selected from the group consisting of ethanol, hexylene glycol, 2-propanol, neopentyl alcohol, isopropyl alcohol, urea, and mixtures thereof. In this example, the organic co-solvent system may include another co-solvent other than the ones listed (but which would not be included in these enumerated weight percentages). In one variant of this example, rather than using the specified solvents described above, the first solvent portion can generally contain high dielectric constant co-solvent with a dielectric constant greater than 30 ε, and the second solvent portion can generally contain low dielectric constant co-solvent with a dielectric constant from 1 ε to 30 ε. Furthermore, regardless of how the solvents are selected for use in the first portion and the second portion, in one example, the organic co-solvent system can also include one or more other co-solvent that may not neatly fit into one of these categories.

In other examples, in the ink composition, method of formulating composition, and method of printing described herein, as mentioned, the first solvent portion can be present at from 15 wt % to 50 wt % and the second solvent portion can be present at from 2 wt % to 15 wt %. However, in some examples, the first solvent portion can be present at from 18 wt % to 30 wt %, and/or the second solvent portion is present at from 4 wt % to 12 wt %.

In each of these examples, there are several components that can be used in the present methodology, or which can be formulated together to generate inks with improved saturation or optical density, including the pigment, the dispersant, and the low dielectric constant co-solvent. The entire formulation, but these three components in particular, contribute to improved saturation as they can be used to generate an ink composition with the pigment dispersed therein nearer pigment crash, but yet still stabilized in the ink. Where a pigment may begin to crash in a volume of ink (loaded in a container, for example) can be determined experimentally by trial and error, or can be determined using colloidal vibrational current techniques described herein. In any event, at what point a pigment may begin to crash for these three components is not universal, but crashing parameters can be readily determined as described herein, followed by formulating ink compositions where the pigment approaches crash, but does not reach a crash point.

With specific reference to the pigment, the pigment is not particularly limited. The particular pigment used will depend on the colorists desires in creating the composition. Pigment colorants can include cyan, magenta, yellow, black, red, blue, orange, green, pink, etc. Suitable organic pigments include, for example, azo pigments including diazo pigments and monoazo pigments, polycyclic pigments (e.g., phthalocyanine pigments such as phthalocyanine blues and phthalocyanine greens, perylene pigments, perynone pigments, anthraquinone pigments, quinacridone pigments, dioxazine pigments, thioindigo pigments, isoindolinone pigments, pyranthrone pigments, and quinophthalone pigments), nitropigments, nitroso pigments, anthanthrone pigments such as PR168, and the like. Representative examples of phthalocyanine blues and greens include copper phthalocyanine blue, copper phthalocyanine green and derivatives thereof such as Pigment Blue 15, Pigment Blue 15:3, and Pigment Green 36. Representative examples of quinacridones include Pigment Orange 48, Pigment Orange 49, Pigment Red 122, Pigment Red 192, Pigment Red 202, Pigment Red 206, Pigment Red 209, Pigment Violet 19, and Pigment Violet 42. Representative examples of anthraquinones include Pigment Red 43, Pigment Red 194, Pigment Red 177, Pigment Red 216, and Pigment Red 226. Representative examples of perylenes include Pigment Red 123, Pigment Red 190, Pigment Red 189, and Pigment Red 224. Representative examples of thioindigoids include Pigment Red 86, Pigment Red 87, Pigment Red 198, Pigment Violet 36, and Pigment Violet 38. Representative examples of heterocyclic yellows include Pigment Yellow 1, Pigment Yellow 12, Pigment Yellow 13, Pigment Yellow 14, Pigment Yellow 17, Pigment Yellow 73, Pigment Yellow 90, Pigment Yellow 110, Pigment Yellow 117, Pigment Yellow 120, Pigment Yellow 128, Pigment Yellow 138, Pigment Yellow 150, Pigment Yellow 151, Pigment Yellow 155, and Pigment Yellow 213. Other pigments that can be used include Pigment Blue 15:3, DIC-QA Magenta Pigment, Pigment Red 150, and Pigment Yellow 74. Such pigments are commercially available in powder, press cake, or dispersions form from a number of sources.

If desired, two or more pigments can be combined to create novel color compositions, but the polymer dispersant to pigment weight ratio and the total pigment load may be considered based on the entire pigment load (cumulative based on all pigments). In one example, a pigment combination can form a red ink by combining a magenta pigment and a yellow pigment, e.g. 50-60 wt % magenta pigment and 40-50 wt % yellow pigment. In another example, the pigment combination can form a green ink by combining a yellow pigment and a cyan pigment, e.g., 65-75 wt % yellow pigment and 25-35 wt % cyan pigment. In yet another example, the pigment combination can form a blue ink by combining cyan pigment and magenta pigment, e.g., 85-95 wt % cyan pigment and 5-15 wt % magenta pigment.

The pigments of the present disclosure can be from nanometers to a micron in size, e.g., 20 nm to 1 μm. In one example, the pigment can be from about 50 nm to about 500 nm in size. Pigment sizes outside this range can be used if the pigment can remain dispersed and provide adequate printing properties.

The pigment load in the ink compositions can range from 3 wt % to 9 wt %. In one example, the pigment load can be from 3 wt % to 7 wt %, or from 5 wt % to 9 wt %. In a further example, the pigment load can be from 4 wt % to 6 wt %, or from 6 wt % to 8 wt %

With specific reference to the polymer in each of these examples, the polymeric dispersant used can be any suitable polymeric dispersant known in the art that is sufficient to form an attraction with the pigment particles. The dispersant may include acid groups, and/or includes both hydrophilic moieties and hydrophobic moieties. In one example, the dispersant may have an acid number ranging from 40 to 180. The ratio of hydrophilic moieties to the hydrophobic moieties can range widely, but in certain specific examples, the weight ratios can be from about 1:5 to about 5:1. In another example, the ratio of hydrophilic moieties to the hydrophobic moieties can range from about 1:3 to about 3:1. In yet another example, the ratio of hydrophilic moieties to the hydrophobic moieties can range from about 1:2 to about 2:1. In one example, the polymeric dispersant can include a hydrophilic end and a hydrophobic end. The polymer can be a random copolymer or a block copolymer or a graft polymer (comb polymer).

The particular polymeric dispersant can vary based on the pigment; however, as mentioned, the hydrophilic moieties typically include acid groups. Some suitable acid monomers for the polymeric dispersant include acrylic acid, methacrylic acid, carboxylic acid, sulfonic acid, phosphonic acid, and combinations of these monomers. The hydrophobic monomers can be any hydrophobic monomer that is suitable for use, but in one example, the hydrophobic monomer can be styrene. Other suitable hydrophobic monomers can include isocyanate monomers, aliphatic alcohols, aromatic alcohols, diols, polyols, or the like, for example. In one specific example, the polymeric dispersant includes polymerized monomers of styrene and acrylic acid at a 5:1 to 1:5 weight ratio.

The weight average molecular weight (Mw) of the polymeric dispersant can vary to some degree, but in one example, the weight average molecular weight of the polymeric dispersant can range from about 5,000 Mw to about 20,000 Mw. In another example, the weight average molecular weight can range from about 7,000 Mw to about 12,000 Mw. In another example, the weight average molecular weight ranges from about 5,000 Mw to about 15,000 Mw. In yet another example, the weight average molecular weight ranges from about 8,000 Mw to about 10,000 Mw.

In order to formulate the pigment dispersion into an ink composition, the pigment dispersion may be combined with an aqueous liquid vehicle. As mentioned, the liquid vehicle can include water, nonionic surfactant, and an organic solvent system as described herein. Other optional ingredients can be present, such as other surfactants, antibacterial agents, UV filters, salts, other colorants, co-solvent other than that mentioned in the organic solvent system, and/or other additives. However, as part of the ink composition, the pigment is included. In one example, along with other parameters used to determine where a pigment may crash in a dispersion and charge stabilization, a lower pigment load may provide for the ability to be more flexible with other parameters.

In further detail, the organic solvent system can include any solvent or combination of solvents that is compatible with the components of the pigment and polymeric dispersant, provided the concentration ranges for the low dielectric constant solvent portion and the high dielectric constant solvent are present. As the liquid vehicle is aqueous, water is one of the major solvents (present at from 30 wt % to 75 wt %, or from 40 wt % to 70 wt %, or from 50 wt % to 70 wt %). If an organic co-solvent is added to prepare the pigment dispersion, that co-solvent can be considered as part of the first solvent portion, the second solvent portion, or as an additional solvent in neither category when formulating the subsequent ink composition. Examples of suitable classes of co-solvents that can be used generally include polar solvents, such as alcohols, amides, esters, ketones, lactones, and ethers. In additional detail, solvents that can be used can include aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. More specific examples of organic solvents can include 2-pyrrolidone, 2-ethyl-2-(hydroxymethyl)-1, 3-propane diol (EPHD), glycerol, N-methylpyrrolidone (NMP), dimethyl sulfoxide, sulfolane, glycol ethers, alkyldiols such as 1,2-hexanediol, and/or ethoxylated glycerols such as LEG-1, etc.

Within this list of co-solvents and categories of co-solvents, there are low dielectric constant co-solvents (having a dielectric constant from 1 ε to 30 ε) as well as high dielectric constant co-solvents (having a dielectric constant greater than 30 ε). The low dielectric co-solvents can be present in the second solvent portion at a total concentration from 2 wt % to 15 wt %, from 4 wt % to 12 wt %, or from 5 wt % to 10 wt %, for example. Examples of low dielectric constant co-solvents include alcohols, such as ethanol, hexylene glycol, 2-propanol, neopentyl alcohol, isopropyl alcohol, as well as the amide, urea. In one example, the low dielectric constant co-solvent(s) can be oxygen-containing low dielectric constant co-solvents, e.g. alcohols, urea, etc. The high dielectric co-solvent can be present in the ink composition (as part of the first solvent portion) at from 15 wt % to 50 wt %, from 18 wt % to 30 wt %, or from 20 wt % to 45 wt %, for example. Examples of high dielectric constant co-solvents that can be used in this portion include 2-pyrrolidinone, 2-ethyl-2-hydroxymethyl-1,3-propanediol (EHPD), glycerol, LEG-1, hydroxyethyl-2-pyrrolidone, triethylene glycol, tetraethylene glycol, or dantocol. As mentioned, other co-solvents can also be present, such as those listed generally elsewhere herein, that do not fit neatly into a specified first solvent portion and/or the second solvent portion category based on dielectric constant, and/or which are not included in a specific first solvent portion list and/or a specific second solvent portion list.

The liquid vehicle can also include surfactants. In general the surfactant can be water soluble and may include alkyl polyethylene oxides, alkyl phenyl polyethylene oxides, polyethylene oxide (PEO) block copolymers, acetylenic PEO, PEO esters, PEO amines, PEO amides, dimethicone copolyols, ethoxylated surfactants, alcohol ethoxylated surfactants, fluorosurfactants, and mixtures thereof. In some examples, fluorosurfactants and alcohol ethoxylated surfactants can be used as surfactants. In one example, the surfactant can be Tergitol™ TMN-6, which is available from Dow Chemical Corporation. Notably, the ink compositions described herein include nonionic surfactant. Thus, if there is only one surfactant or there are multiple surfactants, one or more of the surfactants is a nonionic surfactant. The nonionic surfactant can be present in the ink composition at from 0.1 wt % to 3 wt %, or from 0.3 wt % to 1 wt %. The total surfactant content can be up to about 5 wt % of the ink compositions.

Consistent with the formulations of this disclosure, various other additives may be employed to provide desired properties of the ink composition for specific applications. Examples of these additives are those added to inhibit the growth of harmful microorganisms. These additives may be biocides, fungicides, and other microbial agents, which are routinely used in ink formulations. Examples of suitable microbial agents include, but are not limited to, Acticid^{e}® (Thor Specialties Inc.), Nuosep^{t}™ (Nudex, Inc.), Ucarcid^{e}™ (Union carbide Corp.), Vancid^{e}® (R.T. Vanderbilt Co.), Proxe^{l}™ (ICI America), and combinations thereof. Sequestering agents such as EDTA (ethylene diamine tetra acetic acid) may be included to eliminate the deleterious effects of heavy metal impurities, and buffer solutions may be used to control the pH of the ink. Viscosity modifiers and buffers may also be present, as well as other additives known to those skilled in the art to modify properties of the ink as desired.

The ink compositions described above are particularly suited to provide good color saturation on non-specialized print media (even uncoated paper) but can be suitable for use on any type of substrate of print media. The reason these inks are particularly useful with plain paper is that color saturation is diminished fairly significantly as colorant and liquid vehicle are soaked into the media substrate. This problem is enhanced when the charge stabilization of the pigment is too high. Pigment formulators tend to stabilize inks with high charges, but as discussed herein, such high charge stabilization may not be the best choice for plain paper when trying to enhance saturation. Adding the right concentration of low dielectric constant co-solvent and other co-solvent as described herein can provide higher saturation as the pigment crashes on the paper when liquid vehicle becomes absorbed into the paper fibers.

Suitable examples of media substrates that can be used include, but are not limited to include, cellulose based paper, fiber based paper, inkjet paper, nonporous media, standard office paper, swellable media, microporous media, photobase media, offset media, coated media, uncoated media, plastics, vinyl, fabrics, and woven substrate. That being described, notably, these inks work surprisingly well on plain paper substrates as described herein.

It is noted that, as used in this specification and the appended claims, the singular forms “a,” “an,” and “the” include plural referents unless the content clearly dictates otherwise.

As used herein “aqueous liquid vehicle” or “liquid vehicle” refers to a water-containing liquid medium in which the pigment, polymeric dispersant, nonionic surfactant, and organic solvent vehicle are admixed in to form an ink composition. In addition to water, the aqueous liquid vehicle can include other components including but not limited to other surfactants, biocides, UN filters, preservatives, other co-solvents, and other additives.

When referring to a “polymer dispersant” herein, this refers to a separate additive that is included with the pigment to disperse the pigment. The polymer dispersant can be adsorbed or attracted to the surface of the pigment, but is not covalently attached as is the case with self-dispersed pigments.

Color “saturation” refers to the intensity of color, expressed by the degree from which it differs from white. It can be expressed as C/L*. Notably, saturation relates to color. However, in accordance with examples of the present disclosure, when a black pigment is used, optical density (OD) rather than color saturation can be used to describe the increased intensity. Thus, examples and discussion herein related to color saturation may also be relevant to optical density with respect to black pigment. Thus, any disclosure related to color saturation should be read to include black optical density (for black inks), whether explicitly stated so in a specific context or not.

With respect to the “first solvent portion” and the “second solvent portion,” it is noted that each is described as “containing” either a high dielectric constant co-solvent or a low dielectric constant co-solvent, respectively. These portions may additionally or alternatively be described as containing one or more specific solvent found in a list of co-solvents. In this context, the term “containing” means that only that specific type of co-solvent is present in that portion. To be clear, the organic solvent system may include any co-solvent generally, but in evaluating weight percentages of the first solvent portion and the second solvent portion, only those co-solvents that qualify based on dielectric constant and/or based on a specified list of co-solvents in some other examples are counted, depending on the context.

Weight percentages herein are always based on the ink composition as a whole, even if it is described as being part of a sub-component, such as a liquid vehicle, an organic co-solvent system, a first solvent portion, a second solvent portion, etc. Thus, by way of example for clarity, an organic co-solvent system that includes from 2 wt % to 15 wt % of a second solvent portion means that this component (whether it be a single solvent or multiple solvents that make up the second solvent portion) is present at from 2 wt % to 15 wt % based on the ink composition as a whole. It does not mean that this component is present at from 2 wt % to 15 wt % of the organic co-solvent system.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight ratio range of about 1 wt % to about 20 wt % should be interpreted to include not only the explicitly recited limits of about 1 wt % and about 20 wt %, but also to include individual weights such as 2 wt %, 11 wt %, 14 wt %, and sub-ranges such as 10 wt % to 20 wt %, 5 wt % to 15 wt %, etc.

When referring to an increase or improvement in performance, the increase or improvement is based on printing using Hammermill® Great White 30% Recycled Media as the print medium which was available at the time of filing of the disclosure in the United States Patent and Trademark Office.

### EXAMPLES

The following examples illustrate the technology of the present disclosure. However, it is to be understood that the following is only exemplary or illustrative of the application of the principles of the presented formulations and methods. Numerous modifications and alternative methods may be devised by those skilled in the art without departing from the spirit and scope of the present disclosure. The appended claims are intended to cover such modifications and arrangements. Thus, while the technology has been described above with particularity, the following provide further detail in connection with what are presently deemed to be certain acceptable examples.

### Example 1—Ink Compositions

Polymer-dispersed pigmented inks (Cyan, Magenta, and Yellow—or CMY) were prepared in accordance with the following formulations shown in Table 1, as follows:

TABLE 1
FORMULATIONS

| | | Weight Percent in Ink |
|---|---|---|
| Ingredient | Class | Composition |
| 2-Pyrrolidinone | High ε Co-Solvent | 9 |
| EHPD | High ε Co-Solvent | 10 |
| Glycerol | High ε Co-Solvent | 4 |
| LEG-1 | High ε Co-Solvent | 0.75 |
| Tergitol ® TMN6 | Nonionic Surfactant | 0.60 |
| Acticide ® B20 | Biocide | 0.16 |
| Acticide ® M20 | Biocide | 0.07 |
| Co-Solvent Additive | Low ε Co-Solvent | 5 or 10 |
| Color Pigment Dispersion | Pigment and | 6 (by pigment |
| | Polymer Dispersant | weight) |
| Water | | Balance |

Tergitol ® is available from Sigma-Aldrich; and
Acticide ® is available from Thor.

For each color (CMY), as well as for each color mixture (Red, Green, and Blue—or RGB), four different co-solvents were used (as well as a formulation without a co-solvent), as shown in Table 2, as follows:

TABLE 2
CO-SOLVENT ADDITIVES

| Low Dielectric Constant Co- | Dielectric | Weight Percent in |
|---|---|---|
| Solvent (Co-Solvent Additive) | Constant (ε) | Ink Composition |
| None | — | — |
| Ethanol | 24.5 | 10 |
| Hexylene glycol | 24.5 | 10 |
| 2-Propanol | 17.9 | 10 |
| Urea | 3.5 | 5 |

### Example 2—Saturation

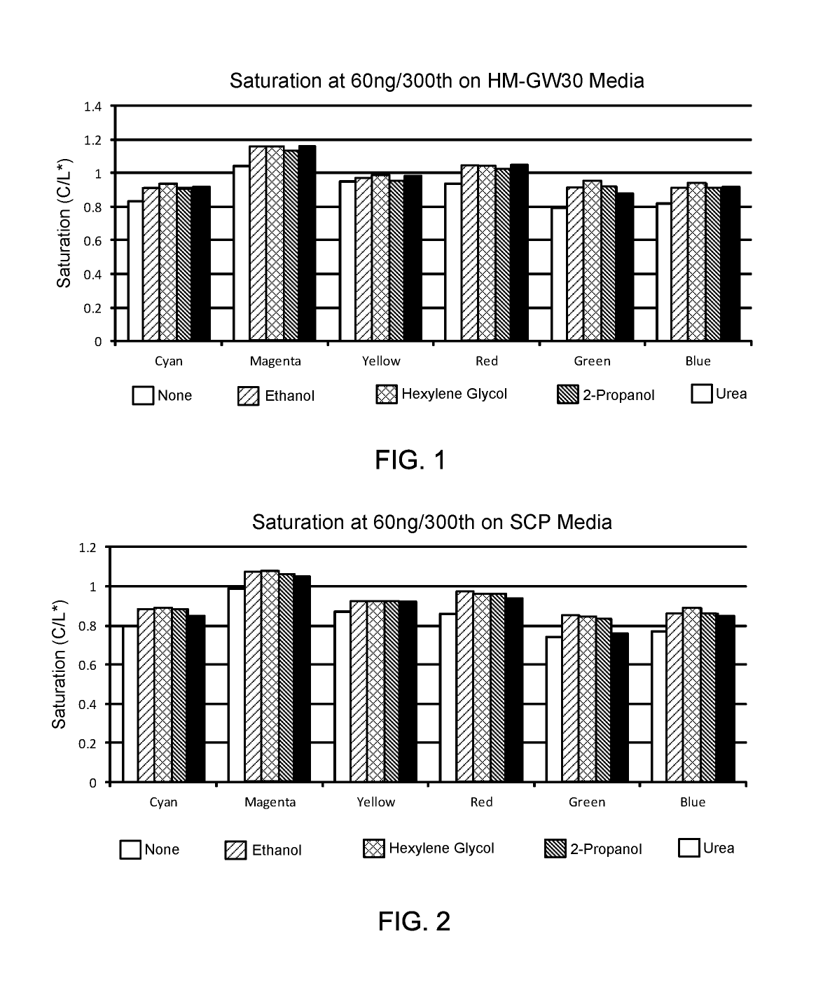

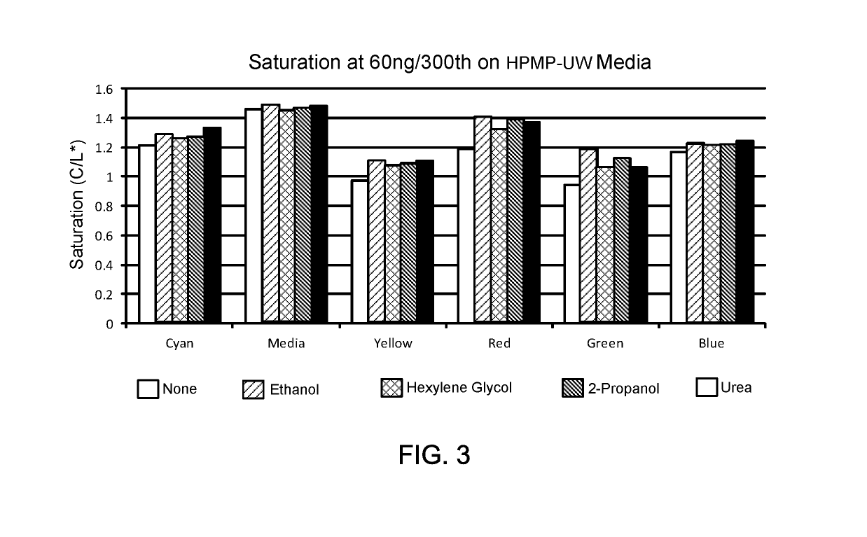

Tables 3-5 below shows saturation (C/L*) for inks with different alcohols at equal concentrations, as well as for urea at one half the concentration, each compared to an ink without the added low dielectric constant co-solvent. The difference between the data in the various tables relates to the plain copy paper that was used. As can be seen, regardless of the type of plain copy paper, there was a general increase in color saturation as the dielectric constant of the organic solvent system is lowered using low dielectric constant co-solvent. The increase in saturation of primary colors (CMY) also results in the increase in saturation for the secondary colors (RGB). The data shown in Tables 3-5 is presented in bar graphs in FIGS. 1-3, respectively.

TABLE 3

| Co-Solvent | Dielectric | Saturation at 60 ng/300th on HM-GW30 Media | | | | | |
|---|---|---|---|---|---|---|---|
| Additive | Constant | C | M | Y | R | G | B |
| None | — | 0.83 | 1.04 | 0.95 | 0.94 | 0.79 | 0.82 |
| Ethanol | 24.5 | 0.91 | 1.15 | 0.97 | 1.04 | 0.91 | 0.91 |
| Hexylene | 24.5 | 0.94 | 1.15 | 0.98 | 1.04 | 0.95 | 0.94 |
| glycol | | | | | | | |
| 2-Propanol | 17.9 | 0.91 | 1.13 | 0.95 | 1.02 | 0.92 | 0.91 |
| Urea | 3.5 | 0.92 | 1.16 | 0.98 | 1.05 | 0.88 | 0.92 |

HM-GW30 is Hammermill ® Great White 30% Recycled Media

TABLE 4

| | Dielectric | Saturation at 60 ng/300th on SCP Media | | | | | |
|---|---|---|---|---|---|---|---|
| Additive | Constant | C | M | Y | R | G | B |
| None | — | 0.80 | 0.99 | 0.87 | 0.86 | 0.74 | 0.77 |
| Ethanol | 24.5 | 0.88 | 1.07 | 0.92 | 0.97 | 0.85 | 0.86 |
| Hexylene | 24.5 | 0.89 | 1.08 | 0.92 | 0.96 | 0.84 | 0.89 |
| glycol | | | | | | | |
| 2-Propanol | 17.9 | 0.88 | 1.06 | 0.92 | 0.96 | 0.83 | 0.86 |
| Urea | 3.5 | 0.85 | 1.05 | 0.92 | 0.94 | 0.76 | 0.85 |

SCP is Staples ® Copy and Print Media

TABLE 5

| | Dielectric | Saturation at 60 ng/300th on HPMP-UW Media | | | | | |
|---|---|---|---|---|---|---|---|
| Additive | Constant | C | M | Y | R | G | B |
| None | — | 1.21 | 1.46 | 0.97 | 1.19 | 0.94 | 1.17 |
| Ethanol | 24.5 | 1.29 | 1.49 | 1.11 | 1.41 | 1.19 | 1.23 |
| Hexylene | 24.5 | 1.26 | 1.45 | 1.08 | 1.32 | 1.06 | 1.21 |
| glycol | | | | | | | |
| 2-Propanol | 17.9 | 1.27 | 1.47 | 1.09 | 1.39 | 1.12 | 1.22 |
| Urea | 3.5 | 1.33 | 1.48 | 1.11 | 1.37 | 1.06 | 1.24 |

HPMP-UW Media is HP ® Multi-Purpose Ultra White Media

While the present technology has been described with reference to certain examples, those skilled in the art will appreciate that various modifications, changes, omissions, and substitutions can be made without departing from the spirit of the disclosure. It is intended, therefore, that the disclosure be limited only by the scope of the following claims.

What is claimed is:

1. An ink composition, comprising:
from 30 wt % to 75 wt % water;
an organic co-solvent system, comprising:
from 15 wt % to 50 wt % of a first solvent portion, the first solvent portion containing high dielectric constant co-solvent with a dielectric constant greater than 30 ε,
from 2 wt % to 15 wt % of a second solvent portion, the second solvent portion containing low dielectric constant co-solvent with a dielectric constant from 1 ε to 30 ε,
from 0.1 wt % to 3 w % nonionic surfactant; and
from 3 wt % to 9 wt % pigment that is dispersed by separate polymer dispersant.

2. The ink composition of claim 1, wherein the second solvent portion includes multiple low dielectric constant co-solvents.

3. The ink composition of claim 1, wherein the low dielectric constant co-solvent is one or more oxygen-containing co-solvent.

4. The ink composition of claim 1, wherein the second solvent portion includes an alcohol.

5. The ink composition of claim 4, wherein the alcohol is ethanol, hexylene glycol, 2-propanol, neopentyl alcohol, isopropyl alcohol, or mixtures thereof.

6. The ink composition of claim 1, wherein the second solvent portion includes urea.

7. The ink composition of claim 1, wherein the second solvent portion contains low dielectric constant co-solvent with a dielectric constant from 1 ε to 10 ε.

8. The ink composition of claim 1, wherein the second solvent portion contains low dielectric constant co-solvent with a dielectric constant from 10 ε to 30 ε.

9. The ink composition of claim 1, wherein the first solvent portion is present at from 18 wt % to 30 wt %.

10. A method of formulating an ink composition, comprising dispersing from 3 w % to 9 wt % pigment with a polymer dispersant and suspended in an aqueous liquid vehicle to form an ink composition, wherein the liquid vehicle comprises water; nonionic surfactant; and an organic co-solvent system, the organic co-solvent system comprising from 15 wt % to 50 wt % of a first solvent portion containing high dielectric constant co-solvent with a dielectric constant greater than 30 ε, and from 2 wt % to 15 wt % of a second solvent portion containing low dielectric constant co-solvent with a dielectric constant from 1 ε to 30 ε.

11. The method of claim 10, wherein the second solvent portion includes an alcohol.

12. The method of claim 10, wherein the second solvent portion includes urea.

13. A method of printing, comprising:
jetting an ink composition onto a plain paper medium, the ink composition including pigment and an organic co-solvent system, the organic co-solvent system comprising:
from 15 wt % to 50 wt % of a first solvent portion containing co-solvent selected from the group consisting of 2-pyrrolidinone, 2-ethyl-2-hydroxymethyl-1,3-propanediol, glycerol, LEG-1, hydroxyethyl-2-pyrrolidone, triethylene glycol, tetraethylene glycol, dantocol, and mixtures thereof, and
from 2 wt % to 15 wt % of a second solvent portion containing co-solvent selected from the group consisting of ethanol, hexylene glycol, 2-propanol, neopentyl alcohol, isopropyl alcohol, urea, and mixtures thereof;
absorbing a portion of the aqueous liquid vehicle in a surface of the plain paper medium; and
crashing the pigment at the surface as a result of the aqueous liquid vehicle absorbing into the plain paper medium without the use of a crashing agent.

14. The method of claim 13, wherein the first solvent portion is present at from 18 wt % to 30 wt %, and wherein the second solvent portion is present at from 4 wt % to 12 wt %.

15. The method of claim 13, wherein the organic co-solvent system includes another co-solvent.
